(19) United States
(12) Patent Application Publication
(10) Pub. No.: US 2013/0273513 A1
(43) Pub. Date: Oct. 17, 2013

(54) MATH MANIPULATIVES FOR TEACHING ROUNDING

(71) Applicant: James Wilson Franklin, Rome, GA (US)

(72) Inventor: James Wilson Franklin, Rome, GA (US)

(21) Appl. No.: 13/863,346

(22) Filed: Apr. 15, 2013

Related U.S. Application Data
(60) Provisional application No. 61/624,040, filed on Apr. 13, 2012.

(51) Int. Cl. G09B 19/02

(52) U.S. Cl. CPC G09B 19/02
USPC 434/203

(57) ABSTRACT

A math manipulative for assisting students with rounding skills includes a number line has ends attached to each of two slides. Windows on the ends of the number line highlight a starting number (on the left hand of the number line) and an ending number (on the right hand of the number line), where the starting and ending numbers straddle the number to be rounded. The math manipulative provides the student with a visual representation of the number to be rounded, allowing the student to choose the starting or ending number to perform the rounding task and solve the rounding problem.

### CROSS-REFERENCE TO RELATED APPLICATION

This application claims the benefit of priority of U.S. provisional application No. 61/624,040, filed Apr. 13, 2012, the contents of which are herein incorporated by reference.

### BACKGROUND OF THE INVENTION

The present invention relates to apparatus and methods for teaching mathematical rounding and, more particularly, to math manipulatives for teaching rounding.

Students often struggle with a visual representation of rounding numbers. The typical manipulatives in education for rounding are paper and pencil, dry erase boards and markers, and a printed number line that only goes up to number 100.

Students may draw a number to help them in rounding numbers. However, the students must first correctly draw the appropriate number line prior to trying to solve the rounding problem. If the number line is drawn incorrectly, student frustration can increase if they do not reach the correct answer to the rounding problem. Pre-printed number lines can be useful, but most number lines go up to 100, and many typical rounding problems involve numbers that are greater than 100.

As can be seen, there is a need for an apparatus and method for assisting students to solve rounding problems.

### SUMMARY OF THE INVENTION

In one aspect of the present invention, a tool for teaching number concepts comprises a first slide having numbers formed therealong; a second slide having numbers formed therealong; a number line having ends slidable along the first and second slides; windows formed on each end of the number line, the windows allowing a user to view a selected one of the numbers along the first slide and the second slide; a central line on the number line dividing the number line in half; and indicators along the number line to indicate numbers between the selected numbers in the windows.

In another aspect of the present invention, a tool for teaching rounding comprises a first slide having numbers formed therealong; a second slide having numbers formed therealong; a number line having slots formed in each end into which the first and second slides and fit and slide therein; windows formed on each end of the number line, the windows allowing a user to view a selected one of the numbers along the first slide and the second slide; knobs on one end thereof, the knobs preventing the number line to slide off the first and second slides over the knobs; a central line on the number line dividing the number line in half; and indicators along the number line to indicate numbers between the selected numbers in the windows.

These and other features, aspects and advantages of the present invention will become better understood with reference to the following drawings, description and claims.

### BRIEF DESCRIPTION OF THE DRAWINGS

FIG. 1 is a front view of a number rounding math manipulative according to an exemplary embodiment of the present invention;

FIG. 2 is a back view of a slide used in the math manipulative of FIG. 1;

FIG. 3 is a front view of exemplary pressure sensitive adhesive stickers for application to the math manipulative of FIG. 1 for creating a fraction math manipulative;

FIG. 4 is a front view of exemplary pressure sensitive adhesive stickers for application to the math manipulative of FIG. 1 for creating a time math manipulative;

FIG. 5 is a front view of exemplary pressure sensitive adhesive stickers for application to the math manipulative of FIG. 1 for creating a weight math manipulative;

FIG. 6 is a front view of exemplary pressure sensitive adhesive stickers for application to the math manipulative of FIG. 1 for creating a money math manipulative;

FIG. 7 is a front view of exemplary slide pressure sensitive adhesive stickers for application to the math manipulative of FIG. 1 for creating a rounding math manipulatives for different powers of 10, including hundreds, thousands, ten thousands, hundred thousands, and millions; and

FIG. 8 is a front view of exemplary number line pressure sensitive adhesive stickers for application to the math manipulative of FIG. 1 for creating a rounding math manipulatives for different powers of 10, including hundreds, thousands, ten thousands, hundred thousands, and millions.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a math manipulative for assisting students with rounding skills. The math manipulative includes a number line has ends attached to each of two slides. Windows on the ends of the number line highlight a starting number (on the left hand of the number line) and an ending number (on the right hand of the number line), where the starting and ending numbers straddle the number to be rounded. The math manipulative provides the student with a visual representation of the number to be rounded, allowing the student to choose the starting or ending number to perform the rounding task and solve the rounding problem.

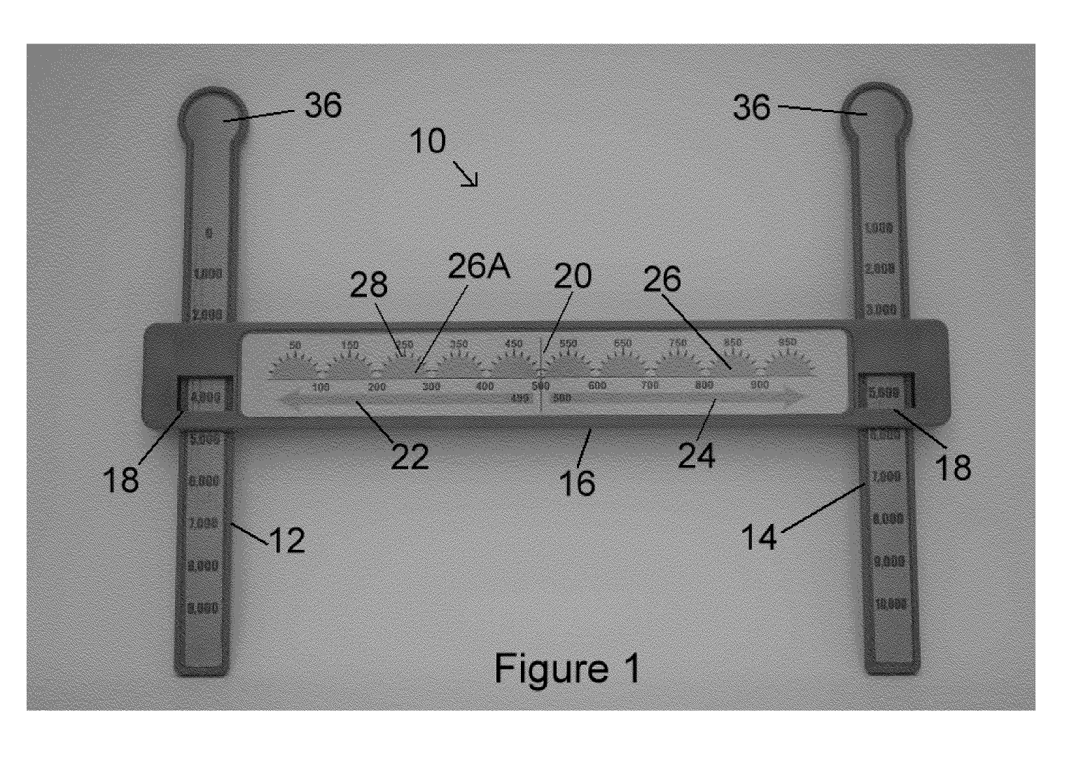

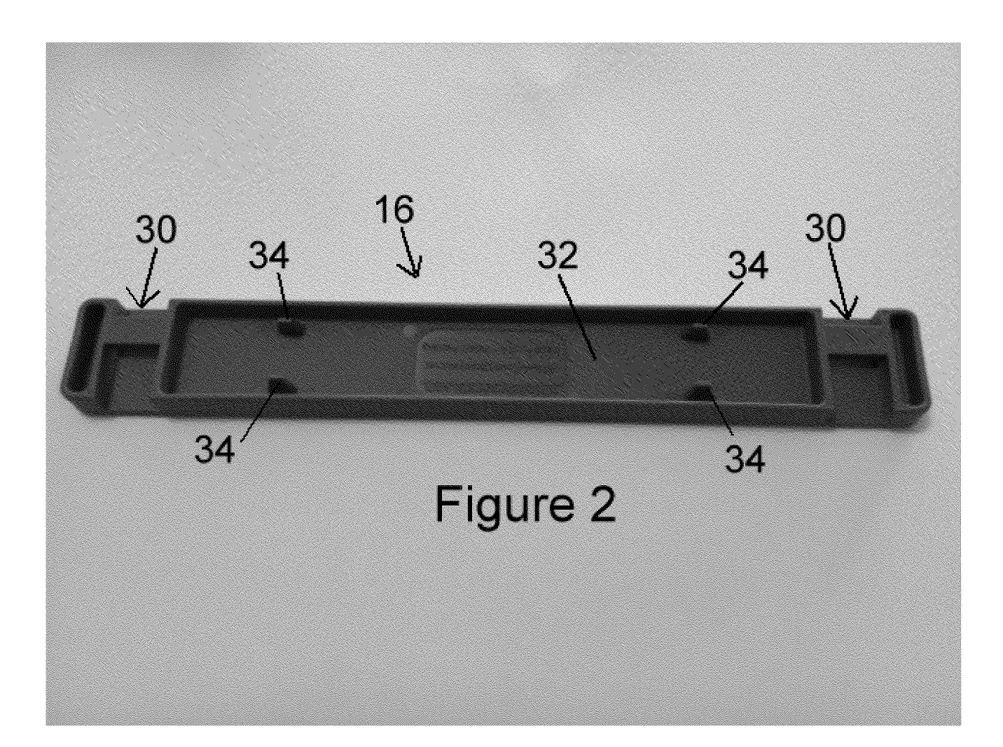

Referring now to FIGS. 1 and 2, a math manipulative 10 includes a first slide 12 and a second slide 14. A number line 16 can attach to and slide along the slides 12, 14. A window 18 on each end of the number line 16 can be used to determine a starting number and an ending number when starting a rounding problem, where the number to be rounded is in between the starting number and the ending number.

The number line 16 can include a central line 20, indicating the mid-point of the number line. In the example shown in FIG. 1, the mid-point is 500. A less than the midpoint arrow 22 and a greater than the midpoint arrow 24 can be provided along the number line 16.

A plurality of indicators 26 can be disposed on the number line 16. The indicators 26 can provide a student a method to count to more accurately determine where their rounding problem number appears on the number line 16. For example, referring to FIG. 1, if the student is asked to round the number 4243 to the nearest thousand, the student could find the location of 4243 on the number line, noting that it would be on the indicator that starts with 200 and ends with 300 (indicator 26A). The student could then find the location of 243 along the indicator 26A, noting the position indicated at location 28. Since this is along the less than the midpoint arrow 22, or since this is closer to the first slide 12 (or on the side of the central line 20 closer to the first slide 12), this number would round to 4000.

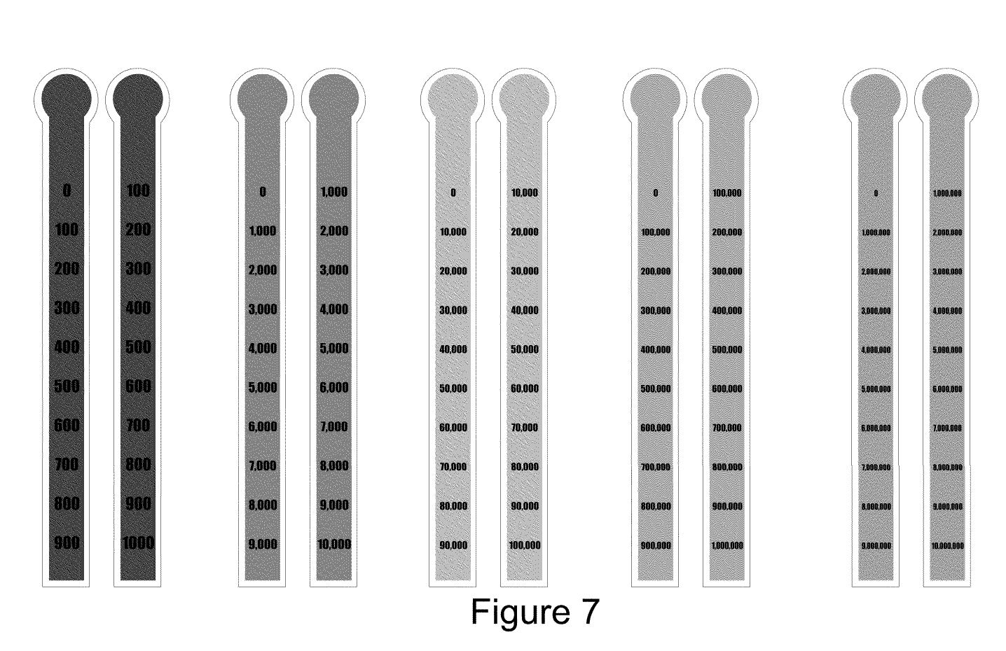

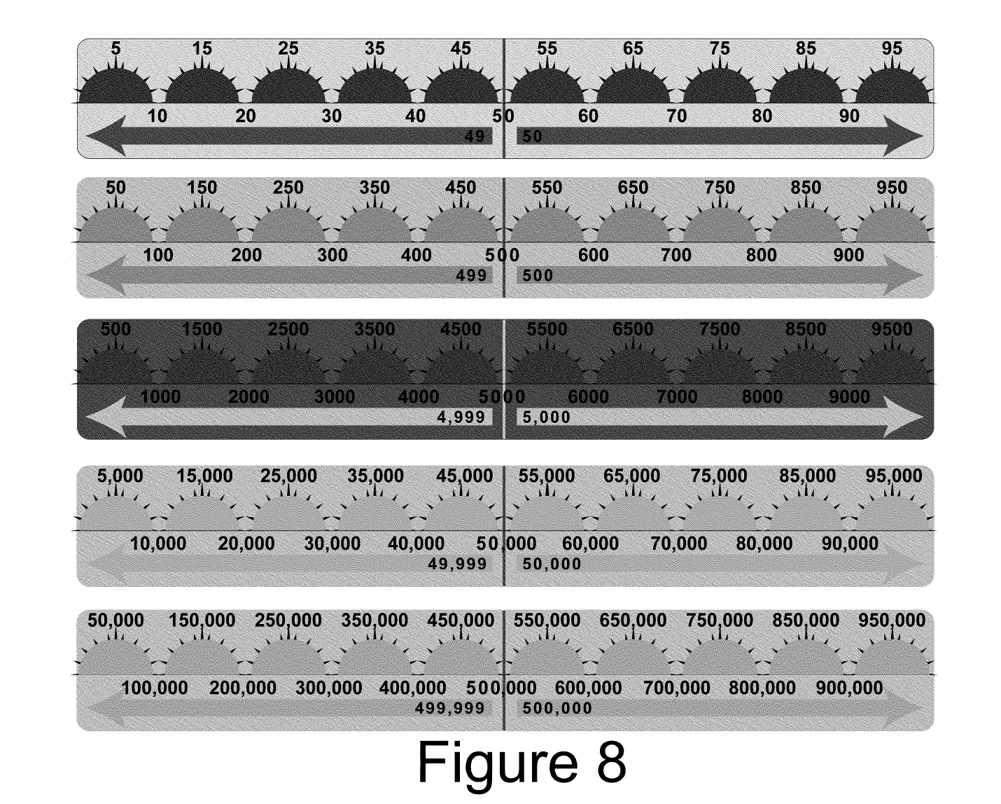

If the student is asked to round to the nearest hundred, the same manipulative could be used, as the indicators 26 could include a midpoint indication, and the student could note that the number falls closer to the 200 side than the 300 side of the indicator 26A. Alternatively, the student could use a hundreds math manipulative (see FIGS. 7 and 8 for various manipulatives).

The slides 12, 14 could be made in various sizes. For example, the slides 12, 14 could be from about 6 inches long to about 24 inches long, from about ½ inch wide to about 2 inches wide, and from about ¼ inch thick to about 1 inch thick. The number line can be from about 6 to about 24 inches long, for example. Of course, other sizes are contemplated within the scope of the present invention. For example, larger sized manipulatives could be designed with large typeface for those with vision impairment. In addition to textual indications, other indications could be used for the numbers on the manipulatives, such as Braille, for example. The upper end of each of the slides 12, 14 can be formed with a knob 36 to prevent the number line 16 from sliding off the top of the slides 12, 14.

As shown in FIG. 2, the back side of the number line 16 can include inserts 30 on each end into which the slides 12, 14 can fit. A hollow 32 can be formed in the back side for storage of the slides 12, 14 therein. Clips 34, or the like, can be used to secure the slides 12, 14 in the hollow 32 on the back side of the number line 16. In some embodiments, the hollow 32 can be deep enough to completely store the two slides 12, 14 therein, allowing for easy stacking and storing of the math manipulatives.

The math manipulatives can be made from various materials by various methods known in the art. For example, the product can be made from a steel mold to ensure quality, durability, and smooth slide movement. A reinforced steel rod can be disposed inside the components to help prevent damage.

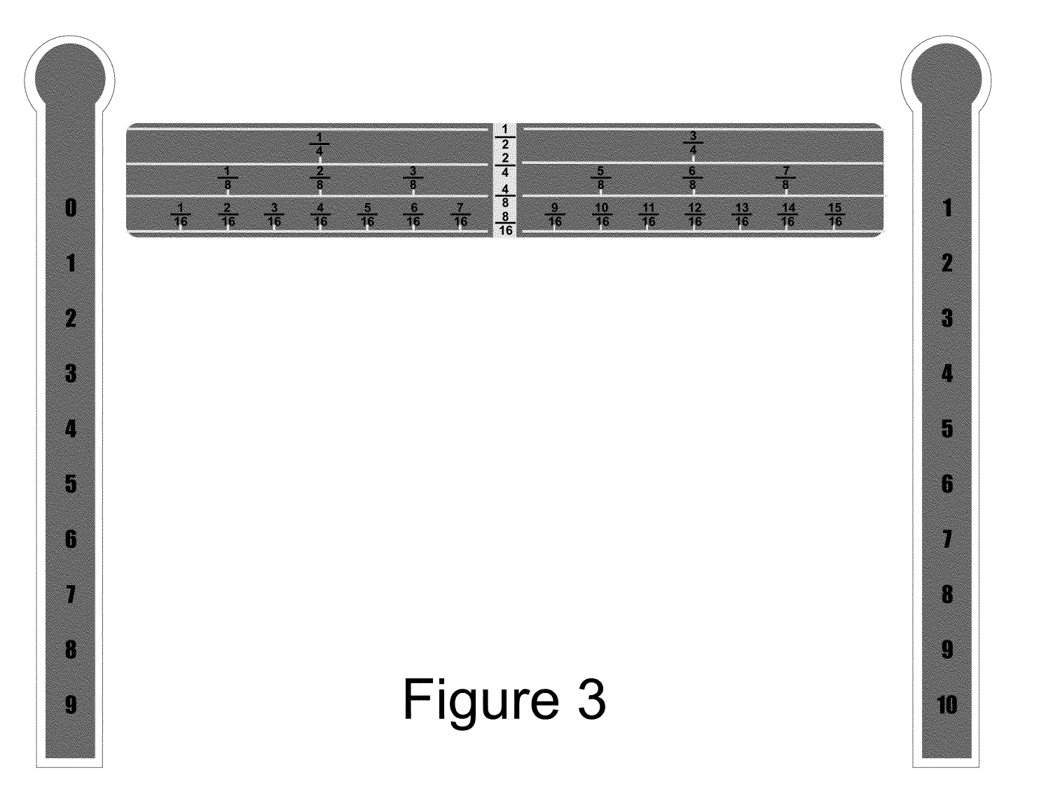

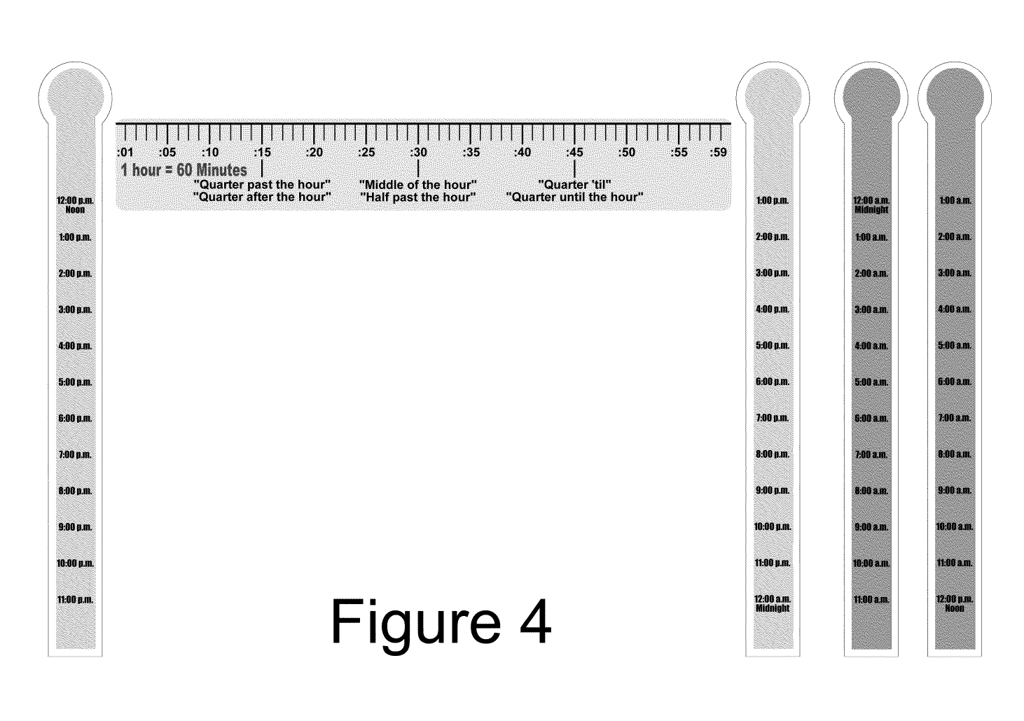

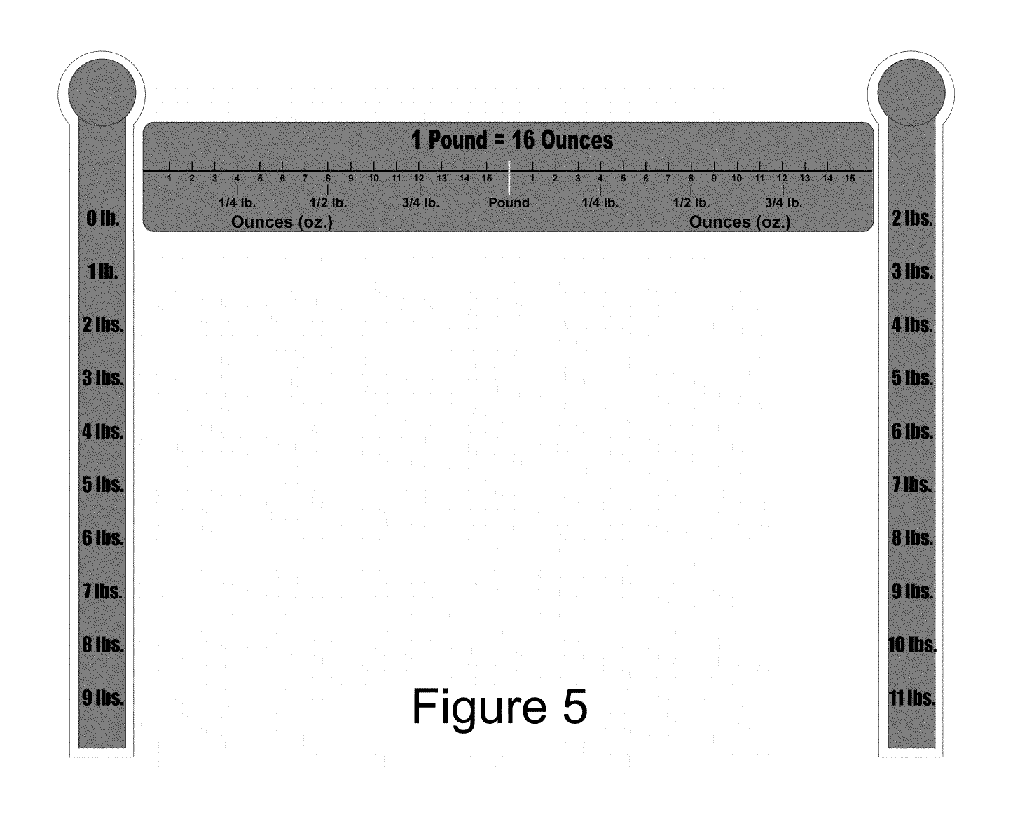

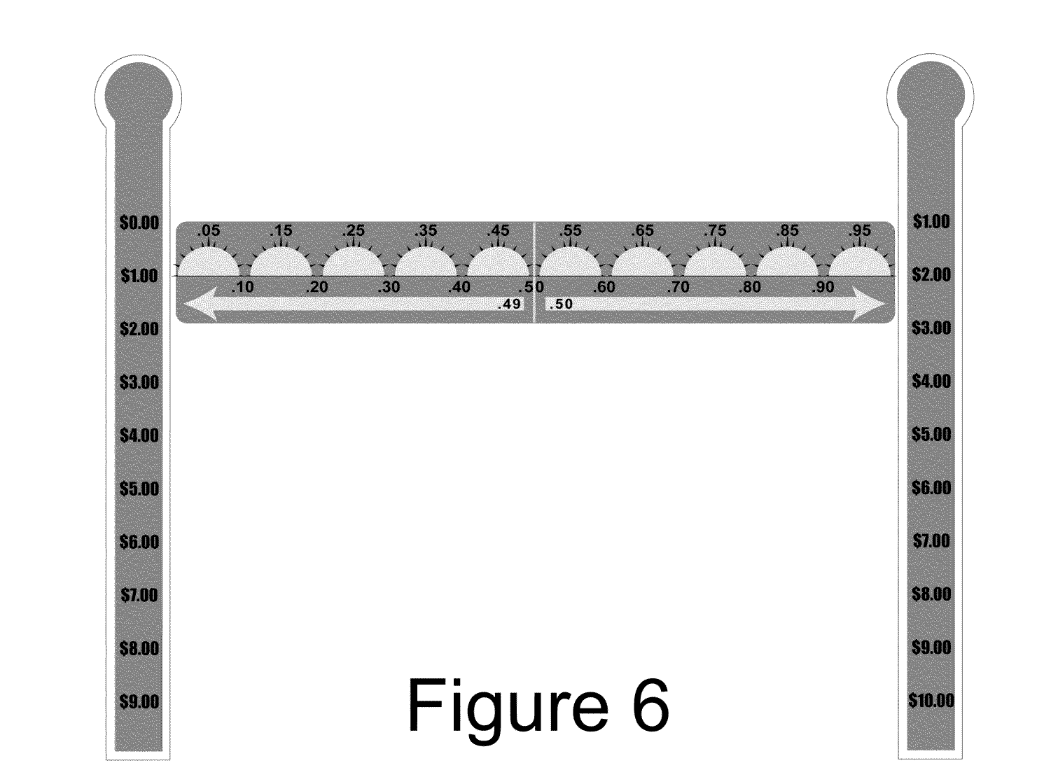

Referring to FIGS. 3 through 6, various uses are contemplated for the math manipulatives in addition to rounding numbers. Various education programs can be developed with respect to fractions (FIG. 3), time (FIG. 4), weight (FIG. 5), money (FIG. 6), or the like.

Referring to FIGS. 7 and 8, it can be seen how various number spans can be covered by the math manipulatives of the present invention. The present invention can be used to round to hundreds, thousands, ten thousands, hundred thousands, millions, and even others beyond those shown in FIGS. 7 and 8.

It should be understood, of course, that the foregoing relates to exemplary embodiments of the invention and that modifications may be made without departing from the spirit and scope of the invention as set forth in the following claims.

What is claimed is:

1. A tool for teaching number concepts, comprising:
a first slide having numbers formed therealong;
a second slide having numbers formed therealong;
a number line having ends slidable along the first and second slides;
windows formed on each end of the number line, the windows allowing a user to view a selected one of the numbers along the first slide and the second slide;
a central line on the number line dividing the number line in half; and
indicators along the number line to indicate numbers between the selected numbers in the windows.

2. The tool of claim 1, wherein the number concept is rounding and the indicators provide a location of a number to be rounded along the number line.

3. The tool of claim 1, wherein the first and second slides have knobs on one end thereof, the knobs preventing the number line to slide off the first and second slides over the knobs.

4. The tool of claim 1, wherein the number line includes slots formed in each end into which the first and second slides fit.

5. The tool of claim 1, further comprising a hollow formed in a back side of the number line, the hollow operable to receive the first and second slides therein.

6. The tool of claim 5, further comprising clips operable to hold the first and second slides in the hollow.

7. A tool for teaching rounding, comprising:
a first slide having numbers formed therealong;
a second slide having numbers formed therealong;
a number line having slots formed in each end into which the first and second slides and fit and slide therein;
windows formed on each end of the number line, the windows allowing a user to view a selected one of the numbers along the first slide and the second slide;
knobs on one end thereof, the knobs preventing the number line to slide off the first and second slides over the knobs;
a central line on the number line dividing the number line in half; and
indicators along the number line to indicate numbers between the selected numbers in the windows.

8. The tool of claim 7, further comprising a hollow formed in a back side of the number line, the hollow operable to receive the first and second slides therein.

9. The tool of claim 8, further comprising clips operable to hold the first and second slides in the hollow.
